(19) United States
(12) Patent Application Publication
(10) Pub. No.: US 2014/0041999 A1
(43) Pub. Date: Feb. 13, 2014

(54) TOUCH PANEL

(71) Applicant: SAMSUNG ELECTRO-MECHANICS CO., LTD., Suwon (KR)

(72) Inventors: Jung Ryoul Yim, Suwon (KR); Sang Su Hong, Suwon (KR); In Hyun Jang, Suwon (KR); Seul Gi Kim, Suwon (KR); Kyu Sang Lee, Suwon (KR); Chung Mo Yang, Suwon (KR)

(73) Assignee: SAMSUNG ELECTRO-MECHANICS CO., LTD., Suwon (KR)

(21) Appl. No.: 13/772,073

(22) Filed: Feb. 20, 2013

(30) Foreign Application Priority Data
Aug. 13, 2012 (KR) 10-2012-0088506
Sep. 27, 2012 (KR) 10-2012-0108048

(51) Int. Cl. H01H 1/06

(52) U.S. Cl. CPC H01H 1/06
USPC 200/275

(57) ABSTRACT

Disclosed herein is a touch panel including a transparent substrate, an electrode formed to have a mesh pattern on the transparent substrate, and a wiring formed to have a zigzag pattern on the transparent substrate, having first and second peaks alternately continued in a length direction, and connected to the electrode. Since the electrode and the wiring are formed to have a uniform pattern overall, the electrode and the wiring can be disposed in an active region of the touch panel, and thus, a bezel region can be reduced.

### CROSS REFERENCE TO RELATED APPLICATION

This application claims the benefit of Korean Patent Application No. 10-2012-0088506, filed on Aug. 13, 2012, entitled “Touch Panel”, and Korean Patent Application No. 10-2012-0108048, filed Sep. 27, 2012, entitled “Touch Panel”, both of which are incorporated by reference herein in their entireties.

### BACKGROUND OF THE INVENTION

1. Technical Field

The present invention relates to a touch panel.

2. Description of the Related Art

Due to the development of computers using digital technologies, computer assisted devices have also been developed, and personal computers, portable transmission devices, and other personal dedicated information processing devices perform text and graphic processing by using various input devices such as a key board or a mouse.

However, the rapid increase of an information-oriented society has extended the purpose of computers, such that a currently used key board and mouse serving as input devices are insufficient to effectively drive products. Thus, demand for a device allowing any one to easily input information, as well as being simple and reducing possibility of erroneous manipulation, is increasing.

In addition, interest in techniques regarding an input device, beyond a level satisfying general functions, has been shifted to reliability, durability, innovativeness, designing, processing-related technique, and the like, and in order to achieve such objects, a touch panel (or a touch screen) allowing for input information such as text, graphics, and the like, has been developed as an input device.

A touch panel is a tool installed on a display screen of a flat panel display device such as an electronic notebook, a liquid crystal display (LCD) device, a plasma display panel (PDP), an electroluminescence (EL), or the like, and an image display device such as a cathode ray tube (CRT), or the like, to allow users to select desired information while viewing the image display device.

Types of touch panels are classified into a resistive type touch panel, a capacitive type touch panel, an electro-magnetic type touch panel, a surface acoustic wave (SAW) type touch panel, and an infrared type touch panel. The various types of touch panels are employed in electronic products in consideration of an issue of signal amplification, a difference in resolution, a level of difficulty in a designing and processing technique, optical properties, electrical properties, mechanical properties, environment resistance properties, input properties, durability, economic efficiency, and among them, currently the resistive type touch panel and the capacitive type touch panel are used in the most extensive fields.

For example, Korean Patent Laid Open Publication No. 10-2011-0120157 discloses a capacitive type touch panel. In this touch panel, a plurality of electrodes crosses each other in a biaxial direction on a transparent substrate.

Wirings are formed to be electrically connected to one end of each of the plurality of electrodes, and a flexible printed circuit board (FPCB) is electrically connected to a pad part formed at the end of each of the wirings.

In the related art touch panel having such a structure, the electrodes are disposed in an active region of a transparent substrate exposed through the transparent substrate or exposed through window glass, and the wirings are disposed in a non-active region of the transparent substrate which is not exposed to the outside.

The reason why the wirings are disposed in the non-active region is because the wirings generally have a linear shape, so it does not have uniformity in a pattern with the electrodes disposed in the active region of the transparent substrate.

In other words, when the electrodes are formed to have a mesh pattern, the linear wirings and the electrodes are not uniform in pattern. Thus, if electrodes and wirings are formed together in an active region, visibility of the touch panel deteriorates.

For this reason, in the related art touch panel, wirings are disposed in a non-active region of the transparent substrate, like the touch panel disclosed in the foregoing document.

However, in the related art touch panel structure, since wirings are disposed in the non-active region of the transparent substrate, a width of the non-active region of the touch panel is increased.

Such shortcomings are an obstacle to reducing the size of terminals employing a touch panel structure or incur the necessity of reducing an active region of a transparent substrate as a touch region of a device having the same size.

### SUMMARY OF THE INVENTION

The present invention has been made in an effort to provide a touch panel in which a non-active region of a touch panel is reduced in width by disposing a wiring, together with an electrode, in an active region of a transparent substrate.

The present invention has been made in an effort to provide a touch panel in which an electrode and a wiring of a transparent substrate are formed to have a uniform pattern, thus having enhanced visibility.

According to an embodiment of the present invention, there is provided a touch panel including: a transparent substrate; an electrode formed to have a mesh pattern on the transparent substrate; and a wiring formed to have a zigzag pattern on the transparent substrate, having first and second peaks alternately continued in a length direction, and connected to the electrode.

The electrode may be formed to have a mesh pattern in which parallelogram patterns having the same shape are continuously arranged, wherein, in a column pattern of the electrode, the parallelogram patterns are continuously arranged in a first direction such that first diagonal lines of the plurality of parallelogram patterns are continued on the same line of the first direction.

The wiring may be disposed in proximity of a first column pattern of the electrode and have the first direction as a length direction.

The first peak of the wiring facing the first column pattern may be directly connected to a vertex close to the wiring among vertexes positioned in a direction of a second diagonal line of the parallelogram patterns forming the first column pattern.

A width between first peaks of the wiring may be equal to a width of the first diagonal line of the parallelogram pattern.

The electrode and the wiring may be integrally formed and made of the same material. The transparent substrate may be divided into an active region and a non-active region, and the electrode and the wiring may be formed in the active region.

According to another embodiment of the present invention, there is provided a touch panel including: a transparent substrate; an electrode array formed to have a mesh pattern on the transparent substrate and divided into a first electrode and a second electrode by a cutout portion formed in the mesh pattern; and a wiring array including first and second wirings formed to have a zigzag pattern on the transparent substrate and having first and second peaks alternately continued in a length direction, the first wiring being connected to the first electrode and the second wiring being connected to the second electrode.

The first electrode and the second electrode may be disposed in a vertical direction as the cutout portion is formed in a horizontal direction in the mesh pattern forming the electrode array.

The first electrode and the second electrode may be formed to have a mesh pattern in which parallelogram patterns having the same shape are continuously arranged, wherein, in a column pattern of the first electrode and a column pattern of the second electrode, the parallelogram patterns may be continuously arranged in a vertical direction such that the first diagonal lines of the plurality of parallelogram patterns are continued on the same line of the vertical direction.

A first column pattern of the first electrode may be formed on the same line as that of a second column pattern of the second electrode.

The first wiring may be disposed in proximity of the first column pattern of the first electrode and have a vertical direction as a length direction, and the second wiring may be disposed in proximity of the first column pattern of the second electrode and have the vertical direction as a length direction.

A width between first peaks of the first wiring and the second wiring may be equal to a width of the first diagonal line of the parallelogram pattern.

The first peak of the first wiring facing the first column pattern of the first electrode may be directly connected to a vertex facing the first wiring among vertexes of the parallelogram patterns forming the first column pattern of the first electrode.

The first peak of the second wiring facing the first column pattern of the second electrode may be directly connected to a vertex facing the second wiring among vertexes of the parallelogram patterns forming the first column pattern of the second electrode.

The transparent substrate may have an adjacent section in which the first wiring and the second wiring are adjacent to each other and disposed to be parallel.

In the adjacent section, the second peak of the first wiring and the first peak of the second wiring may be separatedfrom each other in a facing manner.

An end portion of either or end portions of both of the second peak of the first wiring and the first peak of the second wiring may have a linear portion having a length in a vertical direction.

A protrusion may be formed on an upper portion or a lower portion of the linear portion such that it is bent to be protruded in a horizontal direction.

An end portion of any one of the second peak of the first wiring and the first peak of the second wiring may be a linear portion having a length in a diagonal direction, or end portions of both of the second peak of the first wiring and the first peak of the second wiring may be linear portions having a length in the diagonal direction.

The end portions of the second peak of the first wiring and the first peak of the second wiring may be linear portions having a length in a diagonal direction, and the linear portion of the first wiring and the linear portion of the second wiring may be parallel to each other.

In the adjacent section, a linear distance between the first peak of the first wiring and the second peak of the second wiring may be equal to a width of a second diagonal line of the parallelogram pattern, and a linear direction linking the first peak of the first wiring and the second peak of the second wiring may be identical to a direction of the second diagonal line of the parallelogram pattern disposed in the linear direction.

The electrode array and the wiring array may be made of the same material.

The transparent substrate may be divided into an active region and a non-active region, and the electrode array and the wiring array may be formed in the active region.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a plan view illustrating a transparent substrate of a touch panel according to a first embodiment of the present invention;

FIG. 2 is a plan view illustrating an electrode of the touch panel according to a first embodiment of the present invention;

FIG. 3 is an enlarged view of a major part of electrodes depicted in FIG. 2;

FIG. 4 is a plan view of the major part illustrating a structure in which a wiring is connected to the electrode depicted in FIG. 2;

FIG. 5 is a plan view of a major part illustrating an electrode array and a wiring array of touch panel according to a second embodiment of the present invention;

FIG. 6 is an enlarged view of the major part illustrating the wiring array depicted in FIG. 5; and

FIGS. 7 to 10 are enlarged views of major parts illustrating various examples of the wiring array depicted in FIG. 5.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

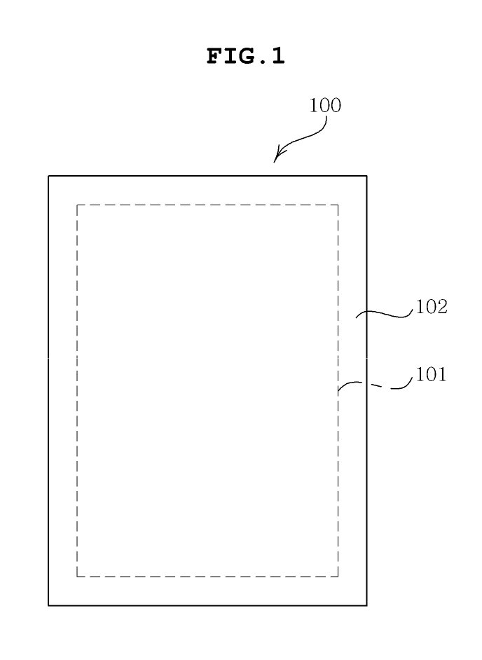

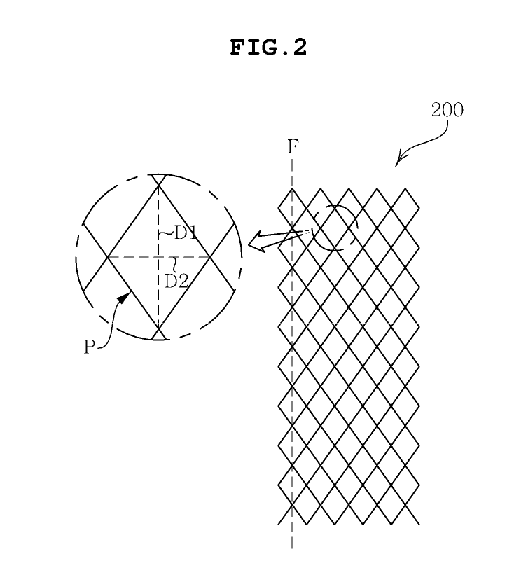

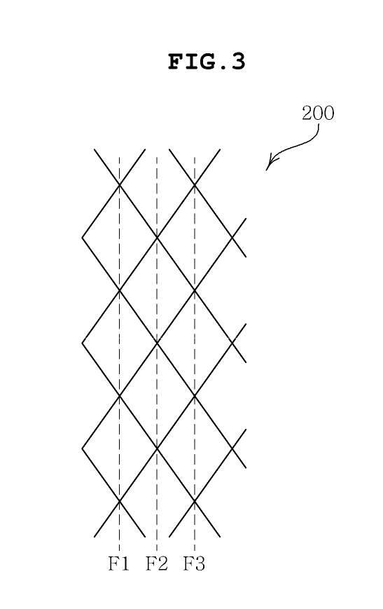

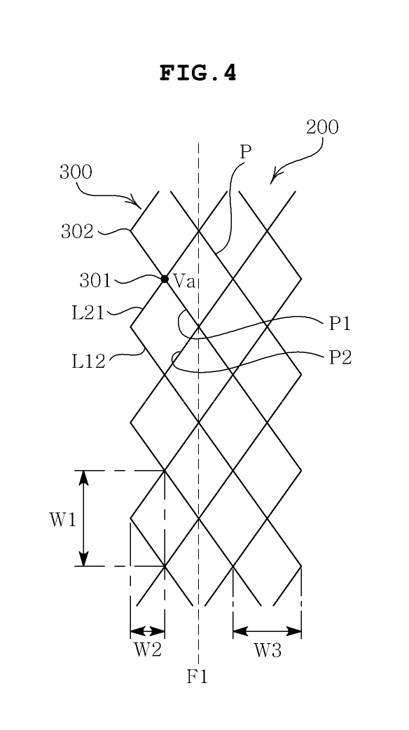

FIG. 1 is a plan view illustrating a transparent substrate of a touch panel according to a first embodiment of the present invention. FIG. 2 is a plan view illustrating an electrode of the touch panel according to a first embodiment of the present invention. FIG. 3 is an enlarged view of a major part of electrode depicted in FIG. 2. FIG. 4 is a plan view of the major part illustrating a structure in which a wiring is connected to the electrode depicted in FIG. 2.

Referring to FIGS. 1 through 4, a touch panel according to a first embodiment of the present invention includes a transparent substrate 100, an electrode (or electrodes) 200 formed to have a mesh pattern on the transparent substrate 100, and a wiring (or wirings) 300 formed to have a zigzag pattern and having first and second peaks alternately continued in a length direction on the transparent substrate 100, and connected to the electrode 200.

The transparent substrate 100 serves to provide a region in which the electrode 200 and the wiring 300 are to be formed. The transparent substrate 100 is required to have bearing power sufficient to support the electrode 200 and the wiring 300 and transparency allowing a user to recognize an image provided by the image display device.

When the foregoing bearing power and transparency are considered, preferably, the transparent substrate 100 is made of polyethylene terephthalate (PET), polycarbonate (PC), polymethyl methacrylate (PMMA), polyethylene naphthalate (PEN), polyethersulfone (PES), a cyclic olefin copolymer (COC), triacetylcellulose (TAC) film, a polyvinyl alcohol (PVA) film, a polyimide (PI) film, polystyrene (PS), biaxially oriented PS (BOPS) containing K resin, glass, tempered glass, or the like, but the present invention is not necessarily limited thereto.

Meanwhile, the transparent substrate 100 may be a window provided on the outermost side of the touch panel. When the transparent substrate 100 is a window, since the electrode 200 (to be described) are directly formed on the window, a process of forming the electrode 200 on the transparent substrate 100 and subsequently attaching the same to a window in manufacturing the touch panel may be omitted, and the overall thickness of the touch panel may be reduced.

As illustrated in FIG. 1, the transparent substrate 100 may be divided into an active region 101 and a non-active region 102 disposed on an outer side of the edges of the active region 101. The active region 101 is a region in which a touch operation is performed by the user, and a screen region in which the user visually views an operational scene of the touch panel. The non-active region 102 is a region formed on the edges of the transparent substrate 100 or the edges of a window, covered by a bezel part (not shown) in black or white, so as not to be exposed to the outside.

The electrode 200 serves to generate a signal when a user's touch is applied, to allow a controller (not shown) to recognize touch coordinates. The signal generated by the electrode 200 is transferred to the controller (not shown) through the wiring 300 (to be described).

The electrode 200 is formed to have a mesh pattern on the transparent substrate 100. As illustrated in FIG. 2, the mesh pattern forming the electrode 200 may be a parallelogram pattern P, in which the same shapes are continuously arranged. FIGS. 2 and 3 illustrate an example in which the parallelogram pattern P has a diamond-like shape. Here, lengths of four sides of the parallelogram pattern P may not be necessarily equal.

A column pattern F of the electrode 200 may be a pattern P of a plurality of parallelograms continuously arranged in a first direction, e.g., in a vertical direction based on FIG. 2. Here, in the pattern P of a plurality of parallelograms, first diagonal lines D1 of the parallelogram pattern P are continuously arranged such that they are continued on the same line in the first direction, thus forming the column pattern F. The electrode 200 may have a pattern in which the column patterns F are continuously arranged in a direction perpendicular to the first direction, i.e., in a horizontal direction based on FIG. 2.

Hereinafter, for the purpose of descriptions, column patterns of the electrode 200 disposed starting from the end of one side of the electrode 200, e.g., column patterns F of the electrode 200 disposed in the end of the left side of the electrode 200 based on FIG. 3 will be designated as a first column pattern F1, a second column pattern F2, a third column pattern F3, and the like.

The wiring 300 are electrically connected to the electrode 200 to transfer a touch signal generated in the electrode 200 to the controller. One end portion of the wiring 300 may be connected to the electrode 200 and the other end portion of the wiring 300 may be positioned in the non-active region 102 of the transparent substrate 100 illustrated in FIG. 1. The FPCB connected to the controller may be electrically connected to the other end portion of the wiring 300.

Meanwhile, as for the formation of electrode in the mesh pattern, when the wirings connected to the electrode are formed to have a linear shape as in the related art touch panel structure, the wiring cannot be disposed in the active region 101 of the transparent substrate 100. In this case, the wirings do not have a uniform shape as that of the pattern of the electrode, so visibility of the touch panel deteriorates.

Thus, the wirings formed to have a linear shape are formed in the non-active region 102, and thus, the related art touch panel has disadvantageously a large non-active region 102.

In an embodiment of the present invention, the wiring 300 and the electrode 200 form the overall uniform pattern, thus reducing the non-active region 102, while maintaining fine visibility of the touch panel, even though the wirings 300 are disposed in the active region 101 of the transparent substrate 100.

To this end, in the present embodiment, as illustrated in FIG. 4, the wirings 300 are formed to have a zigzag pattern on the transparent substrate 100. The wirings 300 are formed in the zigzag pattern as follows.

When the first column pattern F1 illustrated in FIG. 3 is halved in a horizontal direction, the left portion of the first column pattern F1 has a zigzag form in which mountains and valleys are continuously formed in the vertical direction. Thus, when the wirings 300 are formed to correspond to a zigzag shape formed in the left side of the first column pattern F1 in the vertical direction and formed in a position appropriately harmonic with the mesh pattern of the electrode 200 on the transparent substrate 100, the electrode 200 and the wiring 300 may have the overall uniform pattern. When the electrode 200 and the wiring 300 have the overall uniform pattern, although the wirings 300 are formed together with the electrode 200 in the active region 101 of the transparent substrate 100, visibility of the touch panel does not deteriorate.

To this end, the wiring 300 is formed to have a zigzag pattern. Since the wiring 300 is formed to have a zigzag pattern, mountains and valleys are alternately continuously formed in a length direction and, in this case, any one of mountains and valleys may be the first peak 301 and the other may be the second peak 302.

The wiring 300 may be formed at various positions on the transparent substrate 100 at which they may be seen as the uniform pattern together with the electrode 200. For a specific example of a disposition position of the wiring 300, the wiring 300 may be formed on the transparent substrate 100 such that the wirings 300 are disposed in proximity of the first column pattern F1 forming a left side of the electrode 200 and has a length direction as a first direction.

Here, the wiring 300 may be connected to the first column pattern F1 of the electrode 200 by a connection line (not shown). Alternatively, as illustrated in FIG. 4, the first peak 301 of the wiring 300 facing the first column pattern F1 may be directly connected to the first column pattern F1. In detail, any one (Va) of the vertexes positioned in the direction of a second diagonal line D2 (See FIG. 2) in the parallelogram pattern P forming the first column pattern F1 is positioned to be close to the wiring 300. As illustrated in FIG. 4, in the wiring 300, the apex of the first peak 301 is directly connected to the vertex Va so as to be connected to the electrode 200.

In the wiring 300, only any one of the plurality of first peaks 301 formed in the length direction may be connected to the first column pattern F1, or as illustrated in FIG. 4, the plurality of first peaks 301 may be connected to correspond to the plurality of vertexes Va of the first column pattern F1, respectively. To this end, width W1 between the first peaks 301 of the wiring 300 may be equal to a width of the first diagonal line D1 of the parallelogram pattern P.

In addition, the wiring 300 may be formed such that a line L12 continued from the first peak 301 to the second peak 302 is substantially parallel to one side P1 of the parallelogram pattern P and a line L21 continued from the second peak 302 to the first peak 301 is substantially parallel to the other side P2 of the parallelogram pattern P. In this case, the width W2 of the wiring 300 may be equal to half of the width W3 of the column pattern F or close to half of the width W3 of the column pattern F. Since the wirings 300 are formed thusly, the wirings 300 may be matched up with the mesh pattering forming the electrode 200, and the wiring 300 and the electrode 200 may have a uniform pattern overall.

Meanwhile, the foregoing electrode 200 and the wiring 300 may be made of a metal having high electrical conductivity and being easily processible. For example, as the metal, copper (Cu), aluminum (Al), gold (Au), silver (Ag), titanium (Ti), palladium (Pd), chromium (Cr), or an alloy thereof The electrode 200 and the wiring 300 may be formed on the transparent substrate 100 through various methods such as a plating process, a deposition process, and the like. Here, the electrode 200 and the wiring 300 may be integrally formed.

Besides the foregoing metal, the electrode 200 and the wiring 300 may be made of metal silver by exposing and developing a silver halide emulsion layer.

Hereinafter, a second embodiment of the present invention will be described in detail with reference to the accompanying drawings, and here, repeated contents as that described above in the first embodiment will be omitted.

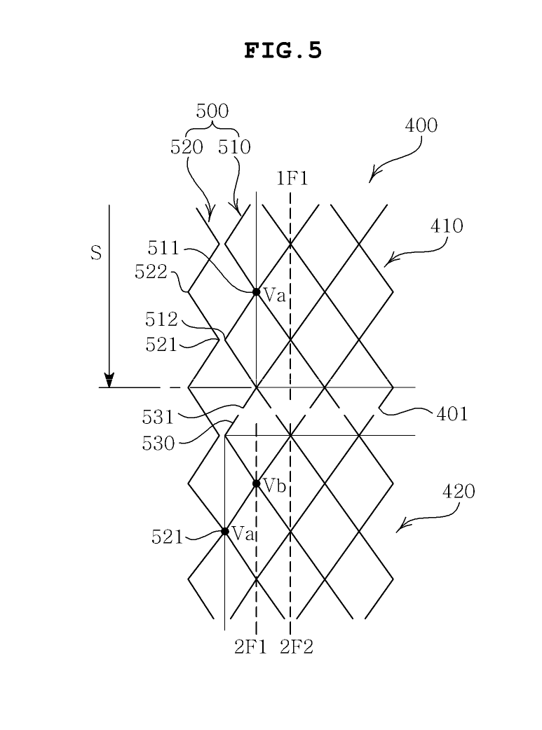

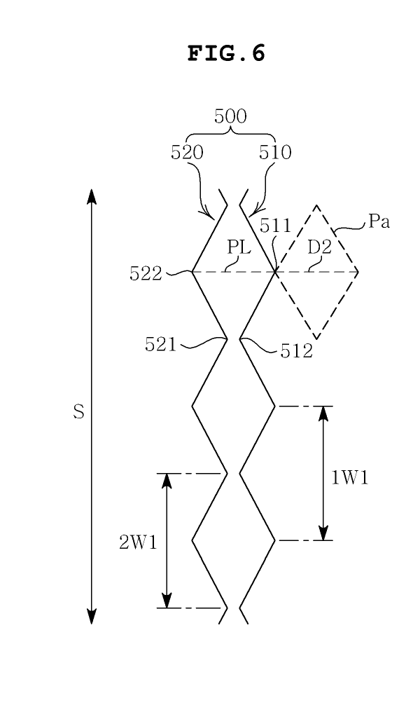

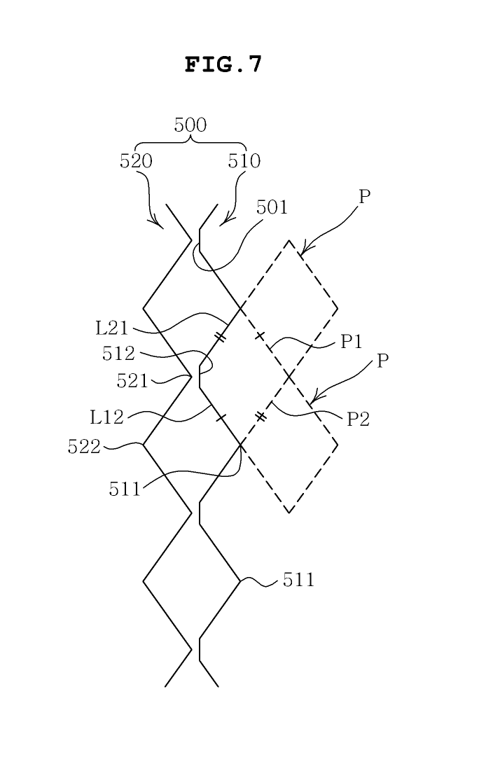

FIG. 5 is a plan view of a major part illustrating an electrode array and a wiring array of touch panel according to a second embodiment of the present invention. FIG. 6 is an enlarged view of the major part illustrating the wiring array depicted in FIG. 5. FIGS. 7 to 10 are enlarged views of major parts illustrating various examples of the wiring array depicted in FIG. 5.

Referring to FIGS. 5 through 8, a touch panel according to the present embodiment includes the transparent substrate 100 (See FIG. 1), an electrode array 400 formed to have a mesh pattern on the transparent substrate 100 and divided into a first electrode 410 and a second electrode 420 by a cutout portion 401 formed on the mesh pattern, and a wiring array 500 including a first wiring 510 and a second wiring 520 formed to have a zigzag pattern on the transparent substrate 100 and having first peaks 511 and 521 and second peaks 512 and 522 alternately continued in a length direction, and here, the first wiring 510 is connected to the first electrode 410, and the second wiring 520 is connected to the second electrode 420.

As illustrated in FIG. 5, the electrode array 400 is formed to have a mesh pattern on the transparent substrate 100. The mesh pattern forming the electrode array 400 may take up a certain region of the active region 101 of the transparent substrate 100.

The electrode array 400 may be divided into the first electrode 410 and the second electrode 420 by the cutout portion 401 formed in the mesh pattern forming the electrode array 400. Alternatively, the electrode array 400 may be divided into three or more electrodes including the first electrode 410 and the second electrode 420.

FIG. 5 illustrates an example in which the first electrode 410 and the second electrode 420 are divided as the cutout portion 401 is formed, for example, in the horizontal direction on the mesh pattern forming the electrode array 400. Here, the first electrode 410 and the second electrode 420 are disposed in the vertical direction.

The first electrode 410 and the second electrode 420 may be divided as the mesh pattern formed therebetween is broken, and the cutout portion 401 refers to the broken portion.

The mesh pattern forming the electrode array 400 is the same as the mesh pattern forming the electrode 200 according to the first embodiment. The electrodes 410 and 420 divided in the electrode array 400 may have various contours.

The wiring array 500 may include the first wiring 510 connected to the first electrode 410 and the second wiring 520 connected to the second electrode 420 when the electrode array 400 is divided into the first electrode 410 and the second electrode 420. Also, the wiring array 500 may include wirings configured as the first wiring 510 and the second wiring 520 or three or more wirings including the first wiring 510 and the second wiring 520 when the electrode array 400 is divided into three or more electrodes including the first electrode 410 and the second electrode 420.

Like the wiring 300 (See FIG. 4) according to the first embodiment as described above, the first wiring 510 and the second wiring 520 may be formed to have a zigzag pattern having the first peaks 511 and 521 and the second peaks 512 and 522 as illustrated in FIGS. 5 and 6.

Here, the first wiring 510 is connected to the first electrode 410. For example, the first wiring 510 may be disposed in proximity of a first column pattern 1F1 of the first electrode 410 and have a first direction as a length direction, e.g., in a vertical direction based on FIG. 5. The first wiring 510 may be directly connected to the vertex Va at which the first peak 511 is close to the first column pattern 1F1 of the first electrode 410.

The second wiring 520 is connected to the second electrode 420. The second wiring 520 is disposed in proximity of a first column pattern 2F1 of the second electrode 420 and have the length direction as a vertical direction. Like the first wiring 510, the second wiring 520 may be directly connected to the vertex Va at which the first peak 521 is close to the first column pattern 2F1 of the second electrode 420.

Here, in order to prevent the second wiring 520, formed in a direction parallel to the length direction of the first wiring 510, from overlapping with the first wiring 510, the first column pattern 2F1 of the second electrode 420 may be formed to be further protruded in a horizontal direction than the first column pattern 1F1 of the first electrode 410. Namely, as illustrated in FIG. 5, a second column pattern 2F2 of the second electrode 420 may be formed on the same line of the first column pattern 1F1 of the first electrode 410, and in this case, the second electrode 420 is configured such that a left side thereof is further protruded leftwardly by a half width of the column pattern F than the left side of the first electrode 410. Thus, the second wiring 520 may be directly connected to the first column pattern 2F1 of the second electrode 420 and formed to be parallel to the first wiring 510 without overlapping with the first wiring 510 although the second wiring 520 have the length direction as a vertical direction.

Meanwhile, reference numeral 530 in FIG. 5 denotes a connection pattern connected from an end portion of the first wiring 510 to the vertex Vb of the parallelogram pattern P placed at the uppermost position of the first column pattern 2F1. As described above, the left side of the second electrode 420 is further protruded leftwardly than the first electrode 410, so a space in which the pattern is not continued may be formed between the end portion of the first wiring 510 and the first column pattern 2F1 of the second electrode 420. Such a space may be a factor degrading visibility of the touch panel. Thus, the connection pattern 530 formed in an end portion of the first wiring 510 to continue the pattern of the first wiring 510, and as the connection pattern 530 is connected to the vertex Vb of the parallelogram pattern P of the first column pattern 2F1 of the second electrode 420, the electrode array 400 and the wiring array 500 may form a uniform pattern overall without a space formed therebetween. In this case, the connection pattern 530 may include a cutout portion 531 to allow the first wiring 510 and the second electrode 420 to be insulated.

The plurality of first peaks 511 and 521 of the first wiring 510 and the second wiring 520 may be directly connected to correspond to the plurality of vertexes Va of the first column patterns 1F1 and 2F1. To this end, the width 1W1 (See FIG. 6) between the first peaks 511 of the first wiring 510 and the width 2W1 (See FIG. 6) between the first peaks 521 of the second wiring 520 may be equal to the width of the first diagonal line D1 of the parallelogram pattern P.

In addition, like the first embodiment, in the first wiring 510 and the second wiring 520, a line continued from the first peaks 511 and 521 to the second peaks 512 and 522 may be substantially parallel to one facing side of the parallelogram pattern P, and a line continued from the second peaks 512 and 522 to the first peaks 511 and 521 may be substantially parallel to the other facing side of the parallelogram pattern P, such that the electrode array 400 and the wiring army 500 are seen to have a uniform pattern.

Meanwhile, as illustrated in FIGS. 5 and 6, the transparent substrate 100 may have an adjacent section S in which the first wiring 510 and the second wiring 520 are disposed to be adjacent to each other in parallel.

Here, in the adjacent section S, the second peak 512 of the first wiring 510 and the first peak 521 of the second wiring 520 face each other and are separated to be insulated from each other.

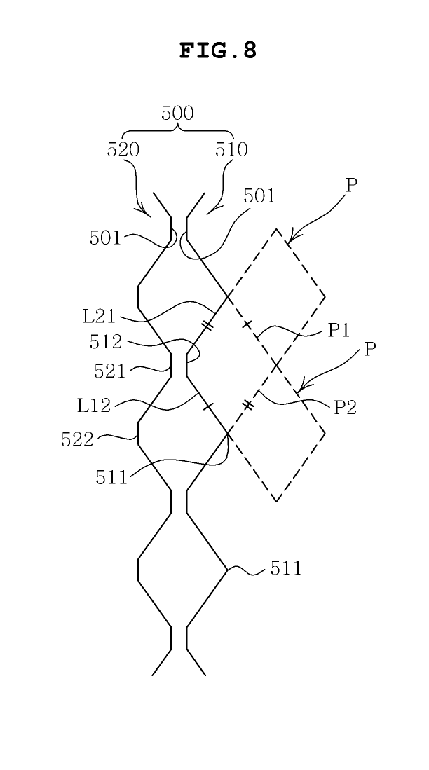

Here, when the widths 1W1 and 2W1 between the first peaks 511 and 521 are equal to the width of the first diagonal line D1 of the parallelogram pattern P, the line linking the first peaks 511 and 521 and the second peaks 512 and 522, the line linking the first peaks 511 and 521 and the second peaks 512 and 522 are formed to be parallel to the facing side of the parallelogram pattern P, and a horizontal width of the wiring array 500 and that of the column pattern F are equal, the second peak 512 of the first wiring 510 and the first peak 521 of the second wiring 520 are connected, rather than being separated. Thus, in order to separate the second peak 512 of the first wiring 510 and the first peak 521 of the second wiring 520, an end portion of any one of the second peak 512 of the first wiring 510 and the first peak 521 of the second wiring 520 may have a linear portion 501 having a length in a vertical direction as shown in FIG. 7. Alternatively, as illustrated in FIG. 8, end portions of both of the second peak 512 of the first wiring 510 and the first peak 521 of the second wiring 520 may have the linear portion 501.

In the adjacent section S, since any one or both of the facing first peak 521 and the second peak 512 of the two wirings 510 and 520 has/have the linear portion 501, although the lines L12 and L21 linking the first peaks 511 and 521 and the second peaks 512 and 522 are formed to be parallel to the facing sides P1 and P2 of the parallelogram pattern P, the space separating the first peak 521 and the second peak 512 can be secured.

Here, the first wiring 510 or the second wiring 520 does not necessarily have the linear portion 501 in the adjacent section S. The first peak 521 and the second peak 512 may be separated by forming the line linking the first peaks 511 and 521 and the second peaks 512 and 522 at an angle different from a slope angle of the facing sides of the parallelogram pattern P, or adjusting a distance between the first wiring 510 and the second wiring 520, namely, by adjusting a horizontal width of the wiring array 500, without a formation of the linear portion 501 as shown in FIGS. 5 and 6.

Meanwhile, the pattern of the adjacent section S formed by the first wiring 510 and the second wiring 520 is preferably seen to be uniform with the mesh pattern of the electrode array 400 overall.

Thus, as described above, when the widths 1W1 and 2W1 between the first peaks 511 and 521 of the first wiring 510 and the second wiring 520 are equal to the width of the first diagonal line D1 of the parallelogram pattern P, when the line linking the first peaks 511 and 521 and the second peaks 512 and 522 is substantially parallel to the facing sides of the parallelogram pattern P, and when the second peak 512 of the first wiring 510 and the first peak 521 of the second wiring 520 are formed to face each other in the adjacent section S, a distance of a linear line PL linking the first peak 511 of the first wiring 510 and the second peak 522 of the second wiring 520 may be equal to the width of the second diagonal line D2 of the parallelogram pattern P as shown in FIG. 6. Also, a direction of the linear line PL may be identical to that of the second diagonal line D2 of a parallelogram pattern Pa disposed in the direction of the linear line PL.

Since the wiring array 500 is formed in this manner, a pattern similar to the parallelogram pattern P may have a shape in which a pattern similar to the parallelogram pattern P is continuously arranged in the vertical direction by the first wiring 510 and the second wiring 520 in the adjacent section S. Thus, the wiring array 500 may be seen to have a uniform pattern overall with the electrode array 400 and although the wiring array 500 is formed together with the electrode array 400 in the active region 101 of the transparent substrate 100, fine visibility of the touch panel can be maintained.

Meanwhile, like the first embodiment of the present invention, in the present embodiment, the mesh pattern forming the electrode array 400 and the pattern forming the wiring array 500 may be made of the same material. A specific material and formation method have been described above in the first embodiment, so a repeated description thereof will be omitted.

Meanwhile, as illustrated in FIGS. 7 and 8, the foregoing linear portions 501 may be disposed such that they are spaced apart at equal intervals in the length direction of the first wiring 510 or the second wiring 520 and have a length direction in which they are continued linearly on the same line.

In this case, when ambient light reaches the linear portions 501, a substantially same phenomenon may arise by light in the linear portions 501. Namely, light absorption or light reflection may take place in the separated respective linear portions 501 substantially in the same manner.

Since the linear portions 501 are disposed in the length direction in which the linear portions 501 may be continued linearly on the same line, the foregoing phenomenon by light may continuously occur on the same line continued in a vertical direction, and thus, a single optical path continued in the vertical direction may be formed. Such an optical path may be visible to a user according to an angle at which the touch panel is viewed.

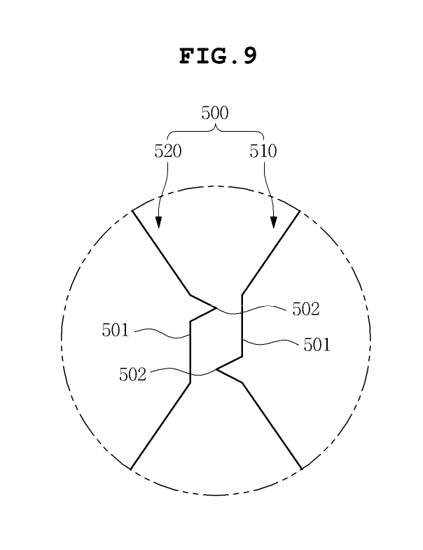

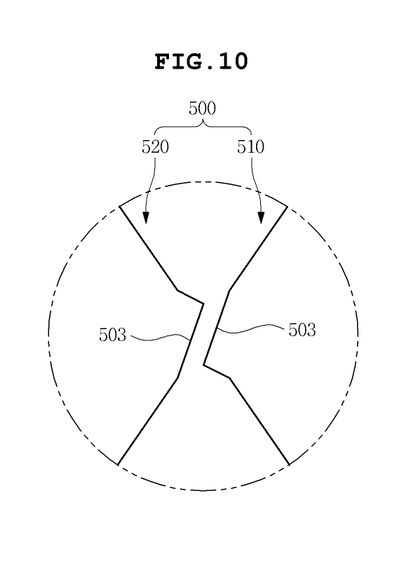

Thus, in order to solve the problem, namely, in order to prevent an optical path from being continued in the vertical direction, another example of the foregoing linear portion 501 may be proposed. Hereinafter, another example of the linear portion 501 will be described in detail with reference to FIGS. 9 and 10.

FIG. 9 is an enlarged view of major parts illustrating another example of the linear portion 501 depicted in a region ‘A’ in FIG. 8, and FIG. 10 is an enlarged view of major parts illustrating still another example of the linear portion 501 depicted in the region ‘A’ in FIG. 8.

In other examples of the linear portion 501 illustrated in FIGS. 7 and 8, as illustrated in FIG. 9, the linear portion 501 may have a protrusion 502 formed on an upper portion or lower portion thereof The protrusion 502 may be bent in an upper or lower portion of the linear portion 501 so as to be protruded in a horizontal direction.

Like the example illustrated in FIG. 9, when end portions of both of the second peak 512 of the first wiring 510 and the first peak 521 of the second wiring 520 are linear portions 501, the protrusion 502 may be formed on only any one of the linear portion 501 of the first wiring 510 and the linear portion 501 of the second wiring 520, or as illustrated, the protrusion 502 may be formed on both of the linear portions 501 of the first wiring 510 and the second wiring 520. In the case in which the protrusion 502 is formed on both of the linear portions 501 of the first wiring 510 and the second wiring 520, the linear portion 501 of any one of the first wiring 510 and the second wiring 520 may have the protrusion 502 formed on an upper portion thereof and the linear portion 501 of the other of the first wiring 510 and the second wiring 520 may have the protrusion 502 formed on a lower portion thereof, as illustrated. In this case, the protrusions 502 may be formed to be protruded in the direction of the peaks 512 and 521 that face each other.

Although not shown, even when an end portion of any one of the second peak 512 of the first wiring 510 and the first peak 521 of the second wiring 520 is the linear portion 501 (Please see FIG. 7), the foregoing protrusion 502 may be formed on the linear portion 501.

With the protrusion 502 formed on the linear portion 501, different phenomena such as light absorption, light reflection, or the like, occurs in the protrusion 502 and the linear portion 501 when light reaches thereto. Thus, the foregoing optical path that may be formed to be continued in the vertical direction is not formed in the example of the linear portion 501 illustrated in FIG. 9.

In still another example of the linear portion 501 illustrated in FIG. 8, as illustrated in FIG. 10, end portions of both of the second peak 512 of the first wiring 510 and the first peak 521 of the second wiring 520 may be linear portions 503 having a length in a diagonal direction. However, the present invention is not limited thereto and an end portion of only any one of the second peak 512 of the first wiring 510 and the first peak 521 of the second wiring 520 may be a linear portion having a length in the diagonal direction.

Like the example as illustrated, when the end portions of both of the second peak 512 of the first wiring 510 and the first peak 521 of the second wiring 520 are linear portions 503 having a length in the diagonal direction, the facing linear portions 503 may be parallel to each other. Also, a space formed between the linear portions 503 formed to be parallel to each other is formed in the diagonal direction as a length direction.

Thus, according to the example of the linear portion 503 illustrated in FIG. 10, the linear portions 503 disposed to be spaced apart in the length direction of the wiring array 500 are not continued linearly on the same line. Also, as mentioned above, since the space between the linear portions 503 is formed in the length direction as the diagonal direction, the space between the linear portions 503 are not continued linearly on the same line in the length direction of the wiring array 500.

Therefore, even in the case of the example of the linear portion 503 illustrated in FIG. 10, the foregoing optical path that may be formed to be continued in the vertical direction cannot be formed.

As can be noted from the embodiment as described above, the electrode and the wiring or the electrode array and the wiring array are formed to be seen to have the uniform pattern overall, the wiring or the wiring array may be disposed in the active region of the transparent substrate together with the electrode or the electrode array, and thus, a non-active region of the transparent substrate can be reduced.

According to the preferred embodiments of the present invention, the wiring or the wiring array, matched up with the mesh pattern forming the electrode or the electrode array, is formed to have a pattern to be seen uniform overall with the electrode or the electrode array. Thus, although the wiring or the wiring array is disposed in the active region of the transparent substrate, visibility of the touch panel is excellent.

Also, owing to the foregoing advantages, a non-active region of the transparent substrate may be reduced, and since a non-active region of the transparent substrate is reduced, a bezel part of the touch panel can be reduced in width. Accordingly, the structure of the touch panel can be reduced or a screen region in the same touch panel area can be extended.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A touch panel comprising:
a transparent substrate;
an electrode formed to have a mesh pattern on the transparent substrate; and
a wiring formed to have a zigzag pattern on the transparent substrate, having first and second peaks alternately continued in a length direction, and connected to the electrode.

2. The touch panel as set forth in claim 1, wherein the electrode is formed to have a mesh pattern in which parallelogram patterns having the same shape are continuously arranged, wherein, in a column pattern of the electrode, the parallelogram patterns are continuously arranged in a first direction such that first diagonal lines of the plurality of parallelogram patterns are continued on the same line of the first direction.

3. The touch panel as set forth in claim 2, wherein the wiring is disposed in proximity of a first column pattern of the electrode and has the first direction as a length direction.

4. The touch panel as set forth in claim 3, wherein the first peak of the wiring facing the first column pattern is directly connected to a vertex close to the wiring among vertexes positioned in a direction of a second diagonal line of the parallelogram patterns forming the first column pattern.

5. The touch panel as set forth in claim 4, wherein a width between first peaks of the wiring is equal to a width of the first diagonal line of the parallelogram pattern.

6. The touch panel as set forth in claim 1, wherein the electrode and the wirings are integrally formed and made of the same material

7. The touch panel as set forth in claim 1, wherein the transparent substrate is divided into an active region and a non-active region, and the electrode and the wiring are formed in the active region.

8. A touch panel comprising:
a transparent substrate;
an electrode array formed to have a mesh pattern on the transparent substrate and divided into a first electrode and a second electrode by a cutout portion formed in the mesh pattern; and
a wiring array including first and second wirings formed to have a zigzag pattern on the transparent substrate and having first and second peaks alternately continued in a length direction, the first wiring being connected to the first electrode and the second wiring being connected to the second electrode.

9. The touch panel as set forth in claim 8, wherein the first electrode and the second electrode are disposed in a vertical direction as the cutout portion is formed in a horizontal direction in the mesh pattern forming the electrode array.

10. The touch panel as set forth in claim 9, wherein the first electrode and the second electrode are formed to have a mesh pattern in which parallelogram patterns having the same shape are continuously arranged, wherein, in a column pattern of the first electrode and a column pattern of the second electrode, the parallelogram patterns are continuously arranged in a vertical direction such that the first diagonal lines of the plurality of parallelogram patterns are continued on the same line of the vertical direction.

11. The touch panel as set forth in claim 10, wherein a first column pattern of the first electrode is formed on the same line as that of a second column pattern of the second electrode.

12. The touch panel as set forth in claim 11, wherein the first wiring is disposed in proximity of the first column pattern of the first electrode and have a vertical direction as a length direction, and the second wiring is disposed in proximity of the first column pattern of the second electrode and have the vertical direction as a length direction.

13. The touch panel as set forth in claim 12, wherein a width between first peaks of the first wiring and the second wiring are equal to a width of the first diagonal line of the parallelogram pattern.

14. The touch panel as set forth in claim 13, wherein the first peak of the first wiring facing the first column pattern of the first electrode is directly connected to a vertex facing the first wiring among vertexes of the parallelogram patterns forming the first column pattern of the first electrode.

15. The touch panel as set forth in claim 13, wherein the first peak of the second wiring facing the first column pattern of the second electrode is directly connected to a vertex facing the second wiring among vertexes of the parallelogram patterns forming the first column pattern of the second electrode.

16. The touch panel as set forth in claim 13, wherein the transparent substrate has an adjacent section in which the first wiring and the second wiring are adjacent to each other and disposed to be parallel with each other.

17. The touch panel as set forth in claim 16, wherein, in the adjacent section, the second peak of the first wiring and the first peak of the second wiring are separated from each other in a facing manner.

18. The touch panel as set forth in claim 17, wherein an end portion of any one or end portions of both of the second peak of the first wiring and the first peak of the second wiring has or have a linear portion having a length in a vertical direction.

19. The touch panel as set forth in claim 18, wherein a protrusion is formed on an upper portion or a lower portion of the linear portion such that it is bent to be protruded in a horizontal direction.

20. The touch panel as set forth in claim 17, wherein an end portion of any one of the second peak of the first wiring and the first peak of the second wiring is a linear portion having a length in a diagonal direction, or end portions of both of the second peak of the first wiring and the first peak of the second wiring are linear portions having a length in the diagonal direction.

21. The touch panel as set forth in claim 17, wherein the end portions of the second peak of the first wiring and the first peak of the second wiring are linear portions having a length in a diagonal direction, and the linear portion of the first wiring and the linear portion of the second wiring are parallel to each other.

22. The touch panel as set forth in claim 17, wherein, in the adjacent section, a linear distance between the first peak of the first wiring and the second peak of the second wiring are equal to a width of a second diagonal line of the parallelogram pattern, and a linear direction linking the first peak of the first wiring and the second peak of the second wiring is identical to a direction of the second diagonal line of the parallelogram pattern disposed in the linear direction.

23. The touch panel as set forth in claim 8, wherein the electrode array and the wiring array are made of the same material.

24. The touch panel as set forth in claim 8, wherein the transparent substrate is divided into an active region and a non-active region, and the electrode array and the wiring array are formed in the active region.
